(19) United States
(12) Patent Application Publication
(10) Pub. No.: US 2004/0054626 A1
(43) Pub. Date: Mar. 18, 2004

(54) Device for processing local accounts data with different formats, equipment and a method for treating associated data

(75) Inventor: Angel Fuentes, Paris (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ADN Technologies

(21) Appl. No.: 10/245,154

(22) Filed: Sep. 17, 2002

(51) Int. Cl. G06F 17/60

(52) U.S. Cl. 705/42

(57) ABSTRACT

A device for processing accounts data comprises i) a supervision module (9) provided with a memory (10) storing identification data for local terminals, each terminal being provided with local accounting software delivering detailed accounts data in a local format and accompanied by identification data and which can receive detailed local accounts data and identification data transmitted by the local terminals over a telecommunications network, and which can communicate the detailed local accounts data when accompanied by identification data stored in the memory (10); and ii) an interface module (11) that can convert detailed local accounts data communicated by the supervision module (9) into detailed local accounts data in the format of a database (4) with a view to memorising them in a selected first local zone (12) of the database.

The invention relates to the field of processing accounts data in different formats.

Many groups, in particular international groups, are constituted by a plurality of “local” firms or entities which have respective local accounting requirements that depend on the legal and fiscal requirements and obligations of the state in which they are established. The local formats for the local accounting requirements generally differ from each other and from the group accounting format, so it is particularly difficult, if not impossible, to transfer local accounts data from the local firms to the group accounts automatically with a view to bookkeeping and producing consolidated accounts, said “group accounts”.

For that reason, local firms generally have to communicate their local accounts data to the group on paper so that they can be manually input, occasionally after initial processing. However, because of the very large amount of detailed (local) accounts data generated by each local firm, in general only aggregate (local) accounts data is communicated to the group. As a result, the groups and their qualified accountants and auditors can neither check nor provide an audit trail nor analyse the accounting operations of local firms. It is also not possible to carry out any automated remote management of local accounting operations for the local firms in a group.

Those disadvantages are further reinforced by the fact that local firms use different currencies and/or accounting software to generate their local accounts.

Thus, the invention aims to overcome all or part of the disadvantages discussed above.

To this end, the invention provides a device for processing accounts data, comprising:

a supervision module provided with a memory to store local terminal identification data (associated with local firms), each terminal being provided with local accounting software (for example an ERP) which can deliver data representing detailed accounts in a local format (connected to fiscal and legal specifications and obligations), and accompanied by identification data, with a view to their transmission over a telecommunications network (public, for example internet, or private, for example Intranet), said supervision module being connected to the telecommunications network so as to be capable of receiving said detailed local accounts data and said identification data transmitted by said local terminals, and to communicate them when they are accompanied by identification data stored in the memory; and

an interface module that can convert the detailed local accounts data communicated by the supervision module into detailed local accounts data in the format of a database with a view to memorising them in a selected first local zone of said database.

In this manner, each local firm can continue to use its accounting software, which is adapted to the fiscal and legal specifications, and obligations of the state in which it is established, the device of the invention then carrying out centralised homogenisation of all detailed local accounts data transmitted electronically or numerically via the different local terminals into the format of the database. Once homogenisation has been carried out, it then becomes possible to carry out any type of accounting and financial processing on the data stored in the database.

The local format of the detailed local accounts data transmitted by a local terminal to the supervision module preferably relates to a local chart of accounts and/or a local currency and/or local journals.

In accordance with a further characteristic of the invention, the interface module comprises a memory in which correspondence tables between the local formats of each local terminal and the database format are stored, so that conversion can be carried out.

In accordance with a further characteristic, and to allow the local data stored in the database format to be processed, the device can comprise the following features taken separately or in combination:

a local summation module that can extract at least some of the detailed local accounts data stored in the database format and associated with a unique local terminal from the first local zone of the database, then generating from the extracted data local aggregated accounts data associated with the local terminal concerned and in the format of the base, and finally storing these aggregated local data in a second local zone of the database;

a filter module for extracting detailed local accounts data stored in the format of the base and associated with each local terminal from the first local zone, then converting the extracted data into detailed accounts data in a global format (or group format, referring to the group to which the firms belong), and finally storing these detailed global data in a first global zone of the database. In this case, it is advantageous to provide a global summation module that can extract at least some of its detailed global accounts data associated with one and the same local terminal from the first global zone, then generating from these extracted, data global aggregated accounts, data associated with the local terminal concerned and in the global format, and finally storing said local aggregated data in a second global zone of the database. Preferably, the global format (or group format) for the aggregated data stored in the second global zone of the database relates to a global chart of accounts and/or a global currency and/or global journals;

an export module that can transmit to a global terminal requesting it, and in particular to its global accounting software, at least some of the global detailed and/or aggregated data stored in the first and second global zones;

a supervision module that can also receive from the global terminal, via a telecommunications network (possibly the same as that used by the local terminals, but not necessarily), detailed accounts data in the global format, associated with a local terminal, and accompanied by identification data for the global terminal. Clearly, in this case the memory of the supervision module stores the identification data for the global terminals. The supervision module can then communicate to the interface module the detailed accounts data in the global format which it receives from the global terminal when they are accompanied by identification data stored in the memory, so that they can be stored in the database;

a filter module can also extract from the first global zone, on request, detailed accounts data in the global format associated with each local terminal, then convert said extracted data into detailed local accounts data in the database format, and finally store said detailed local data in the first local zone of the database;

connection modules that can be installed in each local or global terminal, intended to be supplied with detailed accounts data via their accounting software, each comprising a memory in which the address of the supervision module is stored to automatically transmit received data to it via the telecommunications network. Advantageously, the connection module installed in each terminal places the detailed local accounts data in data fields that are separated from each other by field indicators, then it constitutes a file comprising the data and the indicators, and finally it transmits the file to the supervision module. On receiving the file, the interface module detects the field indicators to convert the data. It is also particularly advantageous for the connection module to be capable of sending the supervision module a message indicating each change in the local chart of accounts and/or local journal. In this case, the interface module is capable, if necessary, of modifying the format of the database when it receives a message regarding modification of the chart of accounts and/or journal. Clearly, accepting the modification can depend on confirmation from the local terminal;

an input module that, as a function of the authorisations delivered by an administrator, can firstly input events that are subsequently transformable into accounts by a qualified user, and can secondly allow direct input into the database of data modifying or completing the data received from the local firms, this input possibly being carried out in a local format or in a group format.

With the exception of the connection modules that are installed in the local and global terminals, the device of the invention is preferably installed in a server connected to one or more telecommunications networks and to the database. All of its modules, including the connection modules, can be produced in the form of hardware and/or software.

The invention also concerns equipment for processing accounts data comprising i) a device of the type defined above connected to at least one telecommunications network, a database connected to the device to store accounts data in a selected database format, ii) at least two local terminals each comprising local accounting software for supplying data representing detailed accounts data in a local format and accompanied by identification data and each connected to said telecommunications network, and iii) at least one global terminal connected to the telecommunications network.

The invention also concerns a method for processing accounts data comprising at least the following steps:

a) providing a data processing device connected to a telecommunications network and to an accounts database stored in a selected database format, and at least two local terminals connected to the network and each comprising local accounting software which delivers data representing detailed accounts data in a local format;

b) storing the identification data for the local terminals in a memory of the device;

c) establishing a connection, via the network, between a local terminal and the device, to transmit to said device detailed local accounts data accompanied by identification data;

d) converting the detailed local accounts data, which are accompanied by identification data stored in the memory, into detailed local accounts data in the format of the database, then memorising said data in a selected first local zone of the database.

The method can comprise other steps taken separately or in combination, or as complements to steps a) to d), in particular:

in step b), correspondence tables between the local formats of the local terminals and the database format are stored so as to carry out said conversion of step d);

a step e) in which at least some of the detailed local accounts data associated with one and the same local terminal are extracted from the first local zone in the database format, then the extracted data is used to generate local aggregated accounts data associated with the local terminal and in the database format, and finally said aggregated local data is stored in a second local zone of the database;

a step f) in which detailed local accounts data associated with each local terminal are extracted from the first local zone in the database format, then converting said extracted data into detailed accounts data in a global format, and finally storing said global detailed data in a first global zone of the database. In this step, f), certain accounts data belonging to certain charts of accounts can be distributed in at least two global charts of accounts;

a step g) in which at least some of the detailed global accounts data associated with one and the same local terminal are extracted from the first global zone, then the extracted data is used to generate aggregated global accounts data associated with the local terminal and in the global format, and finally said local aggregated data is stored in a second global zone of the database;

a step i) in which, on request from a global terminal identifiable by identification data, at least some of the detailed and/or aggregated data stored in the first and second global zones are extracted, then said extracted data are transmitted to the requesting global terminal. A step j) can then be provided in which the global terminal transmits detailed global accounts data in the global format associated with a local terminal and accompanied by identification data, to the device via a telecommunications network. This step j) can also be followed by a step k) in which the accounts data received in said first global zone of the database are stored. Clearly, this step can only be carried out if the global terminal identification data have been stored in step b);

a step l) in which detailed accounts data in the global format associated with one of the local terminals are extracted from said first global zone, then said extracted data is converted into detailed local accounts data in the database format and finally said local detailed data is stored in the first local zone of the database;

in step c) the detailed local accounts data can be placed in data fields separated from each other by field indicators, then a file comprising data and indicators is constituted, then the file is transmitted to the device so that in step d), conversion can be carried out after detecting the field indicators;

a step m) in which a message indicating each modification to, the local chart of accounts and/or a local journal is addressed to the device. In this, case, at the outlet from step m) a step n) is provided in which the database format is modified when, the chart, of accounts and/or journal requires it. It is, also possible in step n) to request from the local terminal that has emitted a modification message, a confirmation of modification before proceeding to definitive modification of the database format;

a step o) in which, on request, detailed local accounts data in the format of the database associated with a local terminal and stored in the first local zone are converted into detailed local accounts data, then said converted data are transmitted to a local terminal designated in the request.

Further characteristics and advantages of the invention will become apparent from the following description and the accompanying drawings in which:

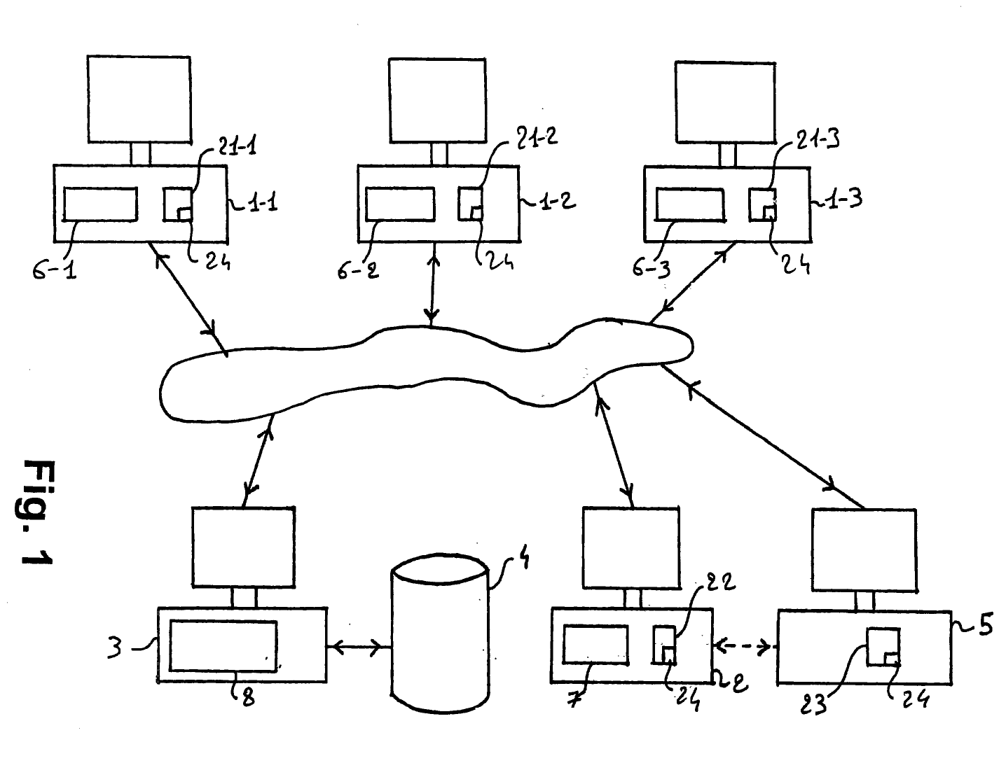

FIG. 1 shows equipment in accordance with the invention in a highly diagrammatic manner;

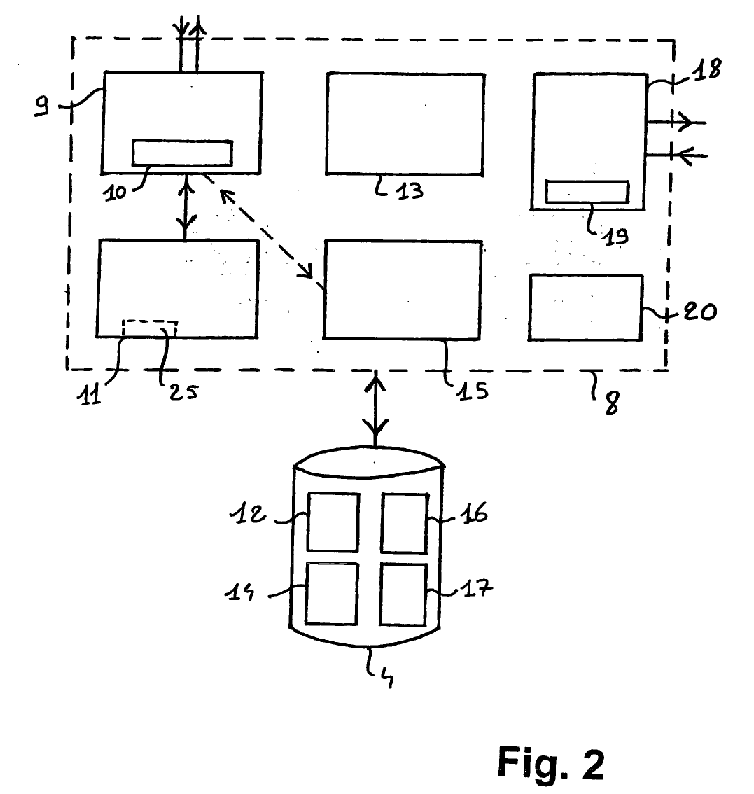

FIG. 2 is a block diagram showing a portion of a device in accordance with the invention in a highly diagrammatic manner;

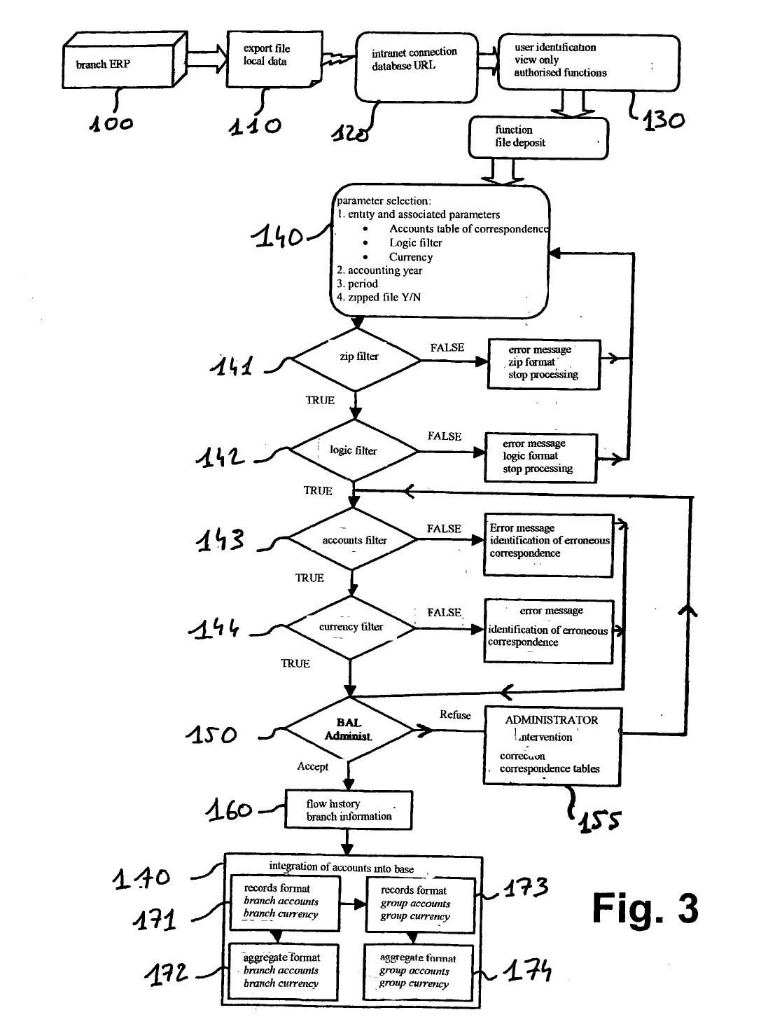

FIG. 3 is an algorithm illustrating file transfer between a local terminal and a server in which the device of the invention has been installed;

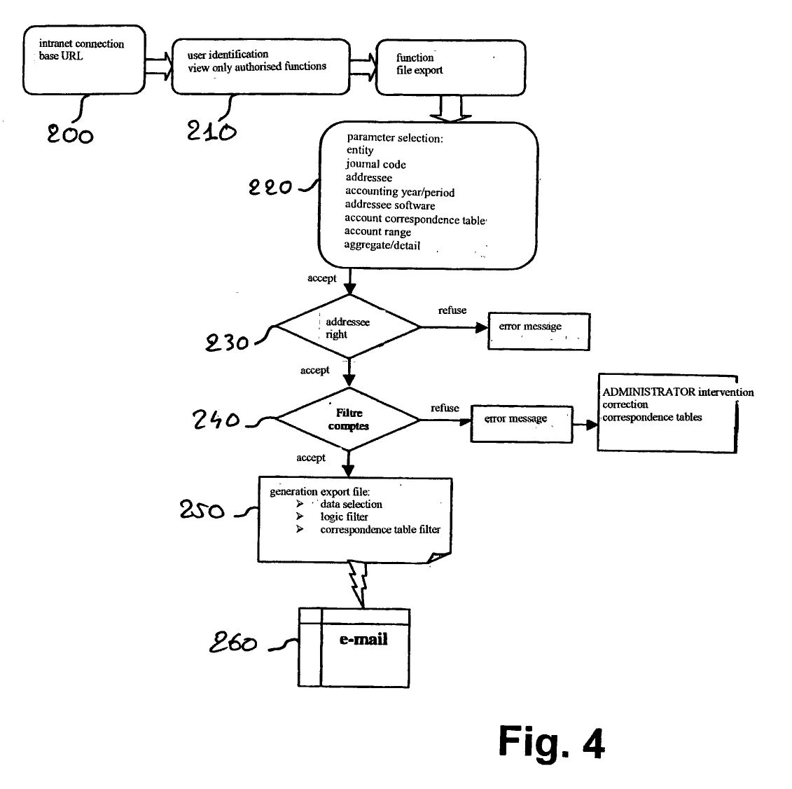

FIG. 4 is an algorithm illustrating export of the file between the server, in which the device of the invention is installed, and a terminal group;

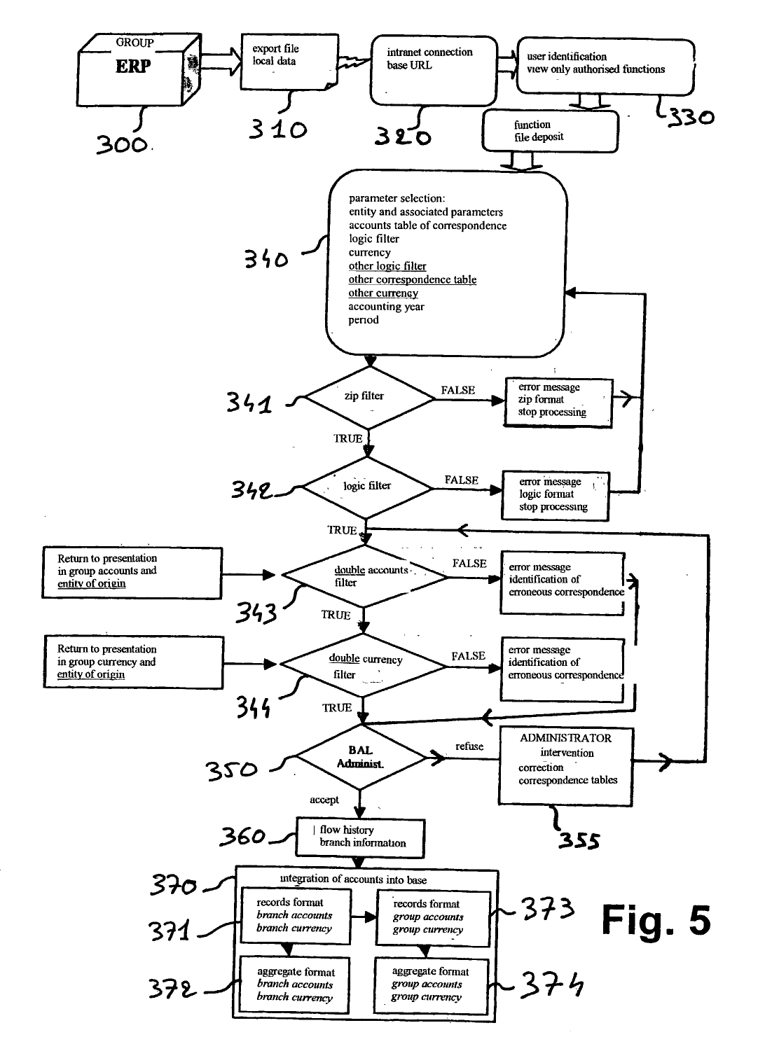

FIG. 5, is an algorithm illustrating transfer of a file re-processed after exporting, between a group terminal and the server in which the device of the invention has been installed; and

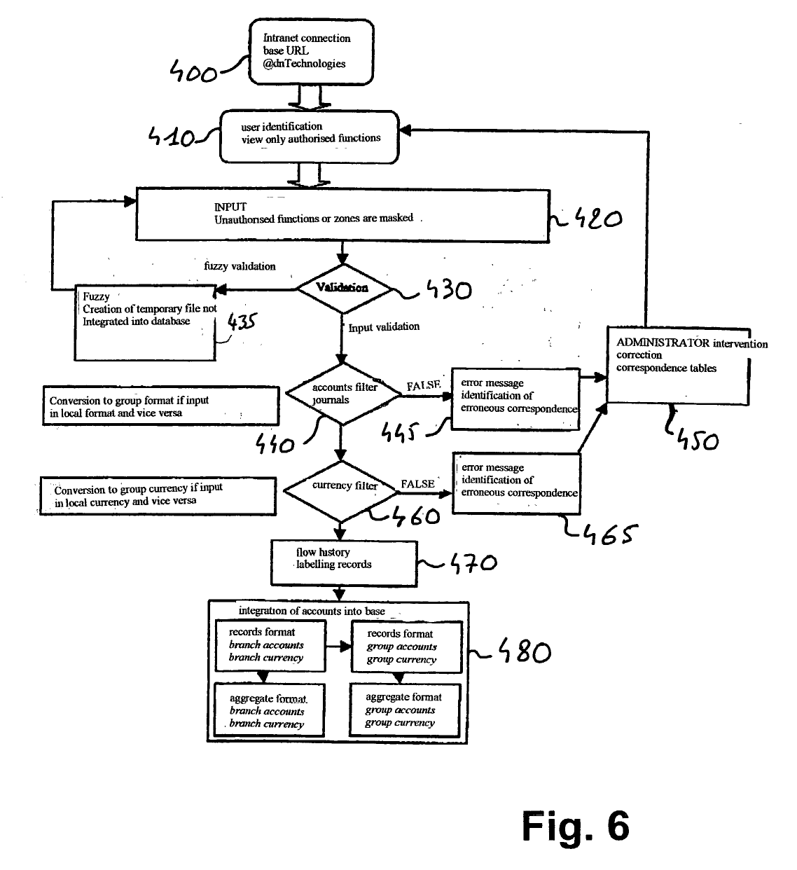

FIG. 6, is an algorithm illustrating data input using an input module of the device of the invention.

The accompanying drawings are definitive in nature. As a result, they not only serve to explain the invention, but also contribute to its definition, if necessary.

In the following description, reference will be made to equipment for processing accounts data of the type illustrated in FIG. 1. More precisely, this example of the equipment is dedicated to a group of firms constituted by a plurality of local firms, each shown here as a local terminal 1-i (i=1 to 3 in this example) and by a mother firm (group, holding) shown by a group terminal 2 (global terminal).

The local terminals 1-i and the group terminal 2 are connected to a telecommunications network which may be public, such as the Internet, or private, such as an Intranet type.

Further, the equipment of the invention comprises a server 3 which manages a database 4, and which is also connected to the telecommunications network. The server is managed by an administrator.

In a variation, the local terminals 1-i can be connected to a public network, for example the Internet, while the group terminal 2 is connected to the server 3 either via a private network for example of the Intranet type, or directly by a cable.

Finally, the equipment can also comprise one or more auxiliary terminals 5, for example for accountants or for external auditors, connected to the telecommunications network and/or to group terminal 2.

In the remainder of the text, all of the terminals will be assumed to be connected to one and the same private Intranet-type telecommunications network.

Each local terminal 1-i is provided with accounting software, 6-i, such as ERP (Enterprise Resource Planning), forming what the skilled person terms an accounting application. The ERP installed in a local terminal 1-i is adapted to the legal and fiscal specifications and obligations of the state in which the local firm is established. Each local firm can use a local, ERP adapted to its specific needs. Such a local ERP 6-i can provide detailed accounts data and aggregated accounts data in a local format, as is well known to the skilled person. Clearly, ‘such ERPs’ provide accounts data in the currency of that state.

Similarly, the group terminal 2 is provided with group accounting software such as a group ERP for providing detailed accounts data and aggregated accounts data in the group format.

The invention aims to allow the use by the group terminal 2 and optionally by the auxiliary terminals 5, of all of the accounts data, whether in detailed or aggregated form, delivered by the local ERPs 6-i of the local firms.

To this end, an accounts data processing device is provided which, as will be seen below, is almost entirely installed in server 3.

The device of the invention, which is illustrated in FIG. 2 by way of non-limiting example, comprises a supervision module 9 which is preferably installed in server 3. This supervision module 9 is intended to ensure connections between the local terminals 1-i and the group terminal 2 via the network(s). It preferably comprises a memory 10 in which are stored identification data (or identifying data) for the local terminals 1-i and for group terminal 2, and optionally those of auxiliary terminals 5 when these are connected to the network and authorised to interrogate the database 4. These identification data are preferably accompanied by respective addresses for the terminals.

As a result, supervision module 9 is supplied with data by the network. It can then receive accounts files, including those submitted by local terminals 1-i or group terminal 2, and check whether those files are accompanied by their identifiers by comparing the identification data accompanying the files received with identifiers stored in memory 10.

When the received identifier effectively corresponds with a known stored identifier, supervision module 9 communicates the accounts data of the file to an interface module 11 intended to convert (or homogenise) the detailed accounts data received in the local format of the local terminal 1-i (because of the use of its local ERP 6-i) into detailed local accounts data in the format of the database 4, and more precisely in the format selected by the group, for storage in database 4. The format of the database can be fixed or the parameters can be edited by the administrator via the device.

Once these detailed local data have been converted into the database format, they are stored in a first zone 12, termed the local zone, of the database 4. These data can then undergo two types of processing. A first type of processing is carried out by a summation module 13. It converts the detailed local accounts data stored in the first local zone 12 into local aggregated accounts data in the database format. Once the detailed local data has been converted into local aggregated data, they are stored in a second local zone 14 of the database 4. A second type of processing is carried out by a filter module 15. Depending on the selected filters, which will be discussed below, the detailed local accounts data stored in the first local zone 12 are converted into detailed accounts data in the group format (or global format). More precisely, the group format is that which is recognised by the group accounting software 7 (or ERP) of the group terminal 2. Once this conversion is complete, the detailed global accounts data are stored in a first zone 16, termed the group (or global) zone of database 4.

Preferably, summation module 13 is also arranged to convert (or sum) the detailed global accounts data (stored in first global zone 16) into aggregated accounts data in the group format (or global format). Once conversion is complete, the global aggregated accounts data are stored in a second global zone 17 of the database 4.

The device of the invention also comprises a data export module 18 that is intended to manage the export of detailed or aggregated accounts data, which are stored in the first 16 and second 17 global zones of the database 4, to group terminal 2, and more particularly to its group ERP 7.

Clearly, the export module 18 can be integrated into the supervision module 9. In fact, the differentiation of the two, modules, supervision and export, is advantageous when, for example, the local terminals 1-i are connected to server 3 via a public network while group terminal 2 is connected to server 3 via a private network. This allows differentiation of the inlets/outlets for the two networks. A local qualified accountant, not identified on an Intranet network, can then receive via the. Internet data from a branch (or local firm) with a view to generating local fiscal documentation. Clearly, this, qualified accountant will preferably not be able to access the database via the Intranet.

When the two modules are differentiated, it is preferable for the export module 18 to comprise a memory 19 in which are stored the identifiers of the terminal groups 2, and optionally those of the auxiliary terminals 5. In this manner, when a group terminal 2 (or auxiliary terminal 5) requires detailed or aggregated accounts data, it can only obtain them if it transmits its identifier in advance and that the identifier is stored in memory 19. Clearly, memory 19 also preferably stores the addresses of the group and auxiliary terminals (if necessary).

The device of the invention can also comprise an input module 20 intended to allow users, preferably not qualified accountants, to input “events” that other, authorised users will subsequently transform into accounts, and can also allow authorised users to input directly into the database data that modify or complete those received from the branches (or local firms). Input can be carried out in a local format or in a group format.

As an example, the administrator distributes to each user one or more authorisations for each dimension of the database and each zone of the input screen, and/or authorisations to impact the database by validating its own input or simply to prepare accounts that are stored in the files outside the database for completion by other authorised users.

Thus, the user can carry out inputting as a function of his/her authorisation. He/she can either create a new input or refresh an input file that has already been recorded in a file outside the database by him/her or another user (this is termed a “fuzzy” file). As an example, if the user has input incomplete data, he/she chooses the “fuzzy file” option to store the input information. A further user, or he/she, can then modify, complete or cancel that, input information depending on his/her authorisation. In contrast, if the input data are complete (and correct), the user validates the acquisition. The database is then supplied directly with this data input in contrast to posting into the administrator's mailbox, which cancels and replaces the data previously stored in the database.

Recording (or validation) of the data input using input module 20 is identical to that carried out during deposit by a local terminal, with the exception of two points: i) the data feed (or increment) the database instead of cancelling or replacing old data in the database, and ii) the input data are accompanied by an input indicator and the identifier of the user who has validated them, this indicator enabling just those “correction” accounts data to be sent to the branch (or local firm) without returning all of its accounts data.

Input module 20 can be installed in certain local, group or auxiliary terminals, or it can be installed in a dedicated terminal connected to the database, optionally via a telecommunications network.

Further, it is particularly advantageous for the device of the invention to comprise connection modules 21-i installed in each local terminal 1-i. Preferably, the group terminal and auxiliary terminals 5 are also supplied with such a connection module 22 or 23.

Each connection module is arranged to ensure transmission of files supplied via the ERPs (local or group) over the network. More precisely, the accounts data, which are contained in the file delivered by an ERP, are of different types, representing particular fields. The connection module preferably places a field indicator in front of the different types of data of the file, to facilitate conversion of data in the local format via interface module 11.

Different types of field that can be used are indicated below by way of example.

A “type” field concerns the type of local format used, i.e., the number of columns separated by a separator character or a fixed length. This field can take “separator” or “fixed” type values.

A “separator” field designates the separator character if the “type” field has the value

A “length” field designates the length of a line in a column, when the “type” field has the value “fixed”.

A “firstdataline” field designates the number of the first line that contains the accounts, data. In some software, the first line can contain the column titles.

A “dateformat” field designates the format of the values of the dates contained in the received file. This format can be of the “yyyymmdd” type, for example.

A “decimalchar” field designates the type of decimal used in the numerical values, in particular the sums.

A “dirnCvalue” field designates the character that indicates that the direction of the accounting operation is a credit.

A “dirmDvalue” field designates the character that indicates that the direction of the accounting operation is a debit.

The “dim” field designates the position in the file of the “dim” field which indicates the direction of the accounting operation.

An “amountD” field designates the position in the file of the field that contains the amount of the debit accounts data.

An “amountC” field designates the position in the file of the field that contains the amount of the credit accounts data.

An “amount” field” designates the position in the file of the field that contains the amount of the accounts data.

A “journal” field designates the position in the file of the field that contains the journal of the accounts data.

A “Novoucher”, field designates the position in the file of the field that contains the voucher number.

A “Noaccount” field designates the position in the file, of the field containing the account number.

A “daterecord” field designates the position in the file of the field containing the date of the accounts record.

A “duedate” field designates the position in the file of the field containing the due date.

A “description” field designates the position in the file of the field containing the description of the accounting record.

An “amountCUR” field designates the position in the file of the field containing the amount in the currency of the accounting record.

A “paymentmethod” field designates the position in the file of the field containing the method of payment.

After having placed the field indicators, the connection module generates a new file that and attaches to it the identifier of the terminal in which it is installed, then it transmits that file to the supervision module 9 via the telecommunications network.

Each field indicator can indicate to the interface module 11 where each piece of information is located to place the data in the local format into the database format, and the form in which this information is presented. From these indicators, the interface module 11 is then capable of re-positioning each piece of accounting information in the database and in its original format or in the reverse direction, it can take a record from the database to restore it to the local format of a local terminal preferably using the correspondence tables stored in a memory 25.

In said local/group correspondence tables, each local firm is identified by a certain number of parameters in correspondence with group parameters, and in particular its accounting software (local ERP), its chart of accounts, its currency, its journals and their correspondences with the group journals, the holding firm to which it is attached and a group code. Further, a correspondence, table is created between each local journal associated with each local firm and the group journals.

All of these correspondence tables are preferably produced prior to transfer (and processing) of the files transmitted by the local firms.

All of the conversion tables and all of the conversion filters are defined with respect to a group and so all types of flow between the different terminals can be envisaged.

It is possible to transfer files from a branch (or local firm) to the database 4, or to export accounting records from the database 4 to a branch (or local firm), whether it concerns the firm involved in those records or another local firm equipped with a different ERP, to re-import records from an ERP that is different from the ERP originating said records and to carry out double filtering (or double conversion).

Preferably, data is automatically transferred from the local terminal to server 3; to this end, each connection module comprises the address of the server 3 receiving the file. It is also possible to envisage that the connection modules are equipped with an encryption module to reinforce the security of data transfer.

The different modules constituting the device of the invention can be produced in the form of software and/or hardware.

The device of the invention can be installed in any type of server such as NT servers and LINUX servers, and preferably, the data is in XML.

By way of example, database 4 can be of the ORACLE 8i type, server 3 controlling the database can be of the TOMCAT type, for example with Jackson Structure Programming, JSP; interactions with the ORACLE 4 database are then preferably carried out in accordance with a JDBC, type interface. Further, it is possible to envisage using an http type server between the network and the supervision module 9, such as an APACHE server, in particular equipped with an OPEN SSL type data encryption module.

In this manner, requests emitted by a local terminal or a group terminal to the http server are made in the form of http requests, while data intended for a local-terminal or group terminal are preferably sent in the form of encrypted HTML pages.

More precisely, the transfer of data from a text, file generated by an accounting application (local terminal 1 or local terminal 2) to the database 4 can be carried out using JAVA using the mechanism indicated below.

Firstly, the file of input data is, read with the description files that correspond to the accounting software which has generated it, then an XML file is created in accordance with a particular DTD (Document Type Definition) from the read datafile, and finally the generated XML file is parsed and the data are stored in database 4.

Such an implementation mode allows easy integration of data from any accounting software (or ERP). It suffices to create a description file corresponding to the text file it generates.

In certain particular cases, i.e., when the accounting software that generates the data files cannot be described using a description file, it is possible to use a JAVA language filter that will create the corresponding XML file from the data file,

Data transfer from the database 4 to an accounting application (local terminal 1 or group terminal 2) is effected by generating a text file in a format that can be read by the addressee accounting application. To this end, as for transfer in the reverse direction, a description file of the text file to be created is employed. In the case where the file format cannot be described by the description file, it is possible to use a specific JAVA filter which will create the text file.

The different data transfers between the terminals and the server will now be described with reference to FIGS. 3 to 5.

The algorithm shown in FIG. 3 describes a method for transferring accounts files between a local terminal 1-i and the database 4 via the device 8 installed in server 3.

In a first step 100, the local ERP 6-i of a local terminal 1-i generates a detailed accounts data file in the local format. This file is modified by the connection module 21-i (by adding field indicators and the identifier for the local terminal 1-i) in a step 110. It is then transmitted in a step 120 over the network to the server 3 the address for which (for example URL) is stored in the memory 24 of connection module 21-i. Then, in a step 130, the supervision module receives the file and verifies the identifier of the emitting local terminal by checking against the identifiers stored in memory 10. Preferably, in this step 130, the supervision module 9 determines the operations (or functions) that are authorised to be carried out on the received file. These functions are stored in memory 10, in correspondence with the identifier of the local emitting terminal. They are authorisations that are delivered by the administrator of server 3.

As an example, in the example shown in FIG. 3, the only function that the emitter (local terminal) is authorised to carry out is to deposit the file in database 4 with a view to its subsequent processing.

The accounts data file is then communicated to the interface module 11. In a step 140, the interface module 11 determines the emplacement of the different filed indicators, and selects those which will allow it to convert the received file in the local format into a file in the format of the database 4. This resembles conversion filter generation. This selection consists, for example, of determining i) the chart of accounts of the emitting local firm, and as a result the associated correspondence table for the accounts (local/database), ii) the accounting software (or ERP) used by the local emitting terminal, and the local currency used. Then, the accounts and their subdivisions into periods are determined. The terms “accounting year” as used here must be taken in their widest sense. Accounting years can be created over 12 periods in the calendar, but also accounting years can be created over 365 calendar periods (for financial statements) or accounting years over 4 periods (for summations intended for financial markets).

Finally, in this step 140 it is also preferably determined whether the received file has been compressed (for example zipped) or otherwise.

All of these parametrical determinations are carried out in sub-steps 141 to 144. As an example, in sub-step 141, it is determined whether the received file must be decompressed (in other words, whether it includes a compression indicator). If not, and the correspondence tables associated with the local emitting terminal indicate that it should have been, or if the file has to be decompressed but does not contain a decompression indicator, an error message is generated in a format intended for the file emitter and processing of the file is stopped. In contrast, if the file is compressed as intended, or if it is not but that is expected, the file is decompressed and we pass on to sub-step 142 in which the type of local ERP is determined. If the local ERP is not the expected ERP (stored in the correspondence tables associated with the local emitting terminal), an error message is generated in a format that can be transmitted to the file emitter and processing of the file is stopped. In contrast, if the type of local software effectively corresponds with that associated with the emitter, the interface module 11 converts the detailed received data in the local format from the local terminal into detailed local accounts data but in the format of the database 4, then we pass on to sub-step 143 in which the chart of accounts and/or the journals associated with the local emitting terminal is determined. If the chart of accounts and/or the journals is/are not that/those expected, an error message is generated which is addressed to the administrator with a view to correcting the correspondence tables in a step 155. In contrast, if the chart of accounts and/or journals is/are that/those expected, we pass on to sub-step 144 in which the type of currency used is determined. If the currency is not that expected, an error message is generated which is transmitted to the administrator with a view to correction of the correspondence tables in a step 155, if necessary. In contrast, if the currency is that expected, in a step 150 a message is generated intended for the administrator of server 3 to indicate to him that the received data are in the correct format (or agree with that expected) then, preferably, the supervision module 9 transmits to the connection module 21-i of the local emitting terminal 1-i, an acknowledgement of receipt which indicates that all of the data contained in the file transmitted to it has been received correctly with their status (“OK” or “not OK”).

Preferably, only the problems detected during steps 141 and 142 stop the processing. When a problem is detected in steps 143 and 144, the supervisor has to decide whether to correct the correspondence tables in step 155. Regardless of the results of steps 143 and 144, the data flow trail is preserved. In fact, when the supervisor consults these error messages he is automatically prompted to make corrections and possibly to repeat data import.

Preferably, as soon as the file data reaches the supervisor's mailbox, they are converted into detailed data in the group format so that the supervisor can consult them if desired before they are definitely stored in the database (step 170).

Then, in a step 160, a flow history is generated that is transmitted to the emitting local firm.

Finally, in a step 170 the data in the different zones 12, 14, 16 and 17 of database 4 are integrated. More precisely, the interface module 11 stores the detailed local accounts data received in first local zone 12 in accounts designating the different local firms (or branches) and in the local currencies. This constitutes sub-step 171.

In sub-step 172, the data stored in the first local zone 12 are summed using summation module 13. This consists of extracting the detailed local accounts data in the database format associated with the local emitting firm and summing the different data to transform them into local aggregated accounts data but still in the format of database 4. These data are then stored in the second local zone 14 of database 4.

A sub-step 173 can then be carried out using filter module 15 into which at least some of the accounts data associated with a certain number of local firms stored in the first local zone 12 are extracted to generate detailed accounts data but this time in a group format (or global format). In fact, the group accounts are fed with data converted into the group currency. Filter module 15 possesses previously created conversion tables which contain all of the currencies used by the different local firms of the group with their respective definitions with respect to the reference currency of the group. Preferably, each currency is associated with different types of rates that are created with the reference currency. Preferably again, the currency correspondence table comprises different rates which have to be used for currency conversions as a function of accounts and periods. These rates can, for example, be stored in a six figure and six decimal format.

For each local firm (or branch, or for each entity), the correspondence tables contain the code for each local account associated with each local firm, the description for each account and the corresponding group account. Further, when a group wishes to return data to local firms, the correspondence tables must be parameterized in an “account for account” mode.

In contrast, groups that do not wish to return accounts to their local firms can gather a plurality of local accounts in the same group account. It is also possible to distribute a local account over a plurality of group accounts by adding distribution percentages to the correspondence tables.

An example of a correspondence table is shown below for a group chart of accounts over a single field.

Correspondence table

| Local account | Description | Group account |
|---|---|---|
| 411 | Clients | 411000 |
| 4110001 | Client 1 | 411001 |
| 4110002 | Client 2 | 411002 |
| 4110003 | Client 3 | 411003 |
| 4110004 | Client 4 | 411004 |
| 401 | Suppliers | 401000 |
| 4010001 | Supplier 1 | 401001 |
| 4010002 | Supplier 2 | 401002 |
| 4010003 | Supplier 3 | 401003 |
| 4010004 | Supplier 4 | 401004 |
| 512 | Banks | 512000 |
| 51200B1 | Bank 1 | 512001 |
| 51200B2 | Bank 2 | 512002 |

A further example of a group chart of accounts defined over four fields and allowing the creation of a group analysis from the basic data from different local firms (or branches) is given below:

Correspondence table

| Local account | Description | Group account |
|---|---|---|
| 411 | Clients | EURO.FRAN.SOC1.411000 |
| 4110001 | Client 1 | EURO.FRAN.SOC1.411001 |
| 4110002 | Client 2 | EURO.FRAN.SOC1.411002 |
| 4110003 | Client 3 | EURO.FRAN.SOC1.411003 |
| 4110004 | Client 4 | EURO.FRAN.SOC1.411004 |
| 401 | Suppliers | EURO.FRAN.SOC1.401000 |
| 4010001 | Supplier 1 | EURO.FRAN.SOC1.401001 |
| 4010002 | Supplier 2 | EURO.FRAN.SOC1.401002 |
| 4010003 | Supplier 3 | EURO.FRAN.SOC1.401003 |

In sub-step 174, at least some of the data stored in the first global zone 16 of database 4 is extracted to convert them, using the summation module, into aggregated accounting records in the group format. Then, the converted data are stored in a second global zone 17 (or group) of the database 4.

Clearly, sub-step 173 can be carried out prior to sub-step 172.

It is also possible to envisage using a data aggregation module and/or a data consolidation module.

Reference should now be made to FIG. 4 to describe an example of a method for exporting data contained in database 4 to a local terminal 1-i.

This method starts with a step 200 in which the network administrator or the group terminal or a local terminal 1-i establishes a connection with server 3 via the network. A procedure for identifying the initiator of the connection (or emitter) is then carried out by supervision module 9 in a step 210. A check is made as to whether the identifier for the emitter is stored in memory 10, and which function(s) this emitter is authorised to carry out. In the example shown in FIG. 4, the emitter is authorised to export files to a local terminal 1-i. A parameter selection procedure is then commenced which will allow the accounts data in the local format to be communicated to the selected local terminal. This parameter selection step 220 is preferably carried out by the interface module 11. As illustrated, in FIG. 4, the entity concerned, the journal codes the addressee, the accounting year and the period, the type of local software, the correspondence tables for the chart of accounts, the accounts ranges, and the type of data (detailed or aggregated), for example, are determined.

In a step 230, the rights of the addressee terminal are determined. This consists of determining whether the dimensions selected by the user who wishes to export data correspond with the authorisations (or rights) it has in those dimensions. The term “dimensions” means the different parameter selections carried out in step 220. As an example a user such as a manager trained to control entities in the Asian zone is not authorised to export data to entities in the American zone. In such a situation, an error message is immediately sent to him. In contrast, if the rights of the addressee correspond with the selected parameters, then in a step 240 the accounts data stored in database 4 which correspond to the selected parameters are extracted. When a problem arises, an error message is generated so that the administrator of server 3 can intervene, for example by correcting the correspondence tables stored in the device. In contrast, if the extraction operation proceeds correctly, possibly involving intervention of the summation module and/or the filter module, the extracted data arrive in interface module 11 which converts them into the local format of the local terminal 1-i concerned, in accordance with its chart of accounts, its local ERP and its local currency. In a step 250, the converted data are communicated to the supervision module 9 which generates a file. Then in a step 260, the file is transmitted to the local terminal 1-i the address of which has already been extracted from memory 10.

It is also possible to envisage a final step in which the local terminal 1-i addresses a notice of receipt to supervision module 9 once it has finished receiving all of the data from database 4.

Reference should now be made to FIG. 5 to describe an example of the method for transferring accounts data corresponding to a selected local terminal between a group terminal 2 and database 4. In this case, data corresponding to a local firm (or entity) stored in the database is exported for processing with the group ERP (or by a qualified accountant or by another entity), then the data is returned to the database.

This transfer method commences with a step 300 in which the group, software 7 (ERP) of group terminal 2 delivers, a file of accounts data, for example detailed data, corresponding to a local terminal 1-i. In a step 310, the connection module 22 of the group terminal 2 constitutes an export file by placing field identifiers and adding its group identifier to the accounts data in the group format. Then in a step 320, the connection module 22 attempts to establish a connection with server 3 by extracting its address.,

Once the connection is established, supervision module 9 engages in a step 330 in a procedure for identifying the file emitter (in this case group terminal 2). To this end, it compares the identifier of the emitter with identifiers stored in memory 10. Then it determines the functions that the group terminal has been authorised by the administrator of server 3 to carry out.

In the example shown in FIG. 5, the authorised function is depositing the file in the database 4.

In a step 340, the interface module 11 selects the parameters that will allow conversion of received data with a view to their storage in database 4. This is achieved using conversion tables.

Here, it has to be checked that the parameters used by the group terminal which has transmitted the file are indeed those which are known to the administrator, and in particular the chart of accounts, journals, type of group software, group currency, type of accounting year and the period used by the group terminal, and any compression mode (for example zipped), and also the type of local software associated with the data processed by the group ERP, its currency, the type of accounting year and the period used by the local terminal concerned, along with any compression mode (for example zipped) have to be determined.

These parameter determinations are carried out in sub-steps 341 to 344. As an example, sub-step 341 determines whether the received file has to be decompressed 2 (or in other words whether it includes, a compression indicator). If this is not the case, and the correspondence tables associated with the emitting, group terminal indicate that there should be or if the file has to be decompressed but it does not include a decompression indicator, a “format error” message is generated to the emitter of the file and processing of the file is stopped. In contrast if the file is compressed as intended, or if it is not compressed, as is intended, the file is decompressed and we pass on to sub-step 342 in which the type of group ERP used is determined. If the group ERP is not that expected (stored in the correspondence tables associated with, the local emitting terminal), a “format error” message is generated and transmitted to the file emitter and file processing is halted. In contrast, if the group software type corresponds with that associated with the emitter, interface module 11 converts the detailed data received in the local format of the local terminal concerned into detailed local accounts data but in the format of the database 4, then we pass on to sub-step 343 in which the chart of accounts and/or the journals associated with the emitting group terminal and those associated with the local terminal concerned are determined. If the chart of accounts and/or the journals of the group terminal is/are not that/those expected, an error message is generated and addressed to the administrator with a view to any correction of the correspondence tables in a step 355. In contrast, if the chart of accounts and/or the journals of the group terminal is/are that/those expected for the group terminal, we pass on to sub-step 144 in which the types of currency used by the group ERP and by the local ERP concerned are determined. If the group currency is not that expected, an error message is generated and transmitted to the administrator with a view to possible correction of the correspondence tables in a step 355. In contrast, if the currency is that expected, a message intended for the administrator of the server 3 is generated in a step 350 to indicate that the received data are in the correct format (or agree with that expected) then, preferably, the supervision module 9 transmits to the connection module 22 of the emitting group terminal 2 an acknowledgement of receipt indicating that it has received all, of the data contained in the file transmitted thereto with their status (“OK” or “not OK”).

Preferably, only the problems detected during steps 341 and 342 cause an interruption to processing. When a problem is detected in steps, 343 and 344, the supervisor has a to decide whether to correct the correspondence tables in a step 355 as a result. Regardless of the result in steps 343 and 344, the data flow trail is preserved. In fact, when the supervisor consults these error messages he is automatically prompted to carry out corrections and optionally to import the data again.

Preferably, as soon as the file data arrives in the supervisor's mailbox, they are converted into detailed local data in the database format so that the supervisor can consult them if desired before they are definitively stored in the database (in step 370).

In a step 360, a flow history is generated that is transmitted to the local emitting firm.

Finally, in a step 370, we proceed to integrating the data in the different zones 12, 14, 16 and 17 of database 4. More precisely, interface module 11 stores the converted detailed local accounts data in the first local zone 12 in records designating the different local firms (or branches) and in local currencies. This constitutes sub-step 371.

In a sub-step 372, the data stored in the first local zone 12 can be summed using a summation module 13. This consists of extracting the detailed local accounts data in the database format associated with the local emitting firm and summing these different data to transform them into local aggregated accounts data but still in the format of the database 4. These data are then stored in the second local zone 14 of the database 4.

A sub-step 373 can then be carried out using a filter module 15 in which at least some of the accounts data associated with a certain number of local firms stored in the first local zone 12 are extracted, to generate detailed accounts data, but this time in a group format (or global format). In fact, the group accounts are fed with data converted into the group currency.

In a sub-step 374, at least some of the data stored in the first global zone 16 of database 4 is extracted to convert them, using a summation module, into aggregated accounts data in the group format. Then, these converted data are stored in a second global zone 17 (or group zone) of the database 4. Clearly, sub-step 373 can be carried out before sub step 372.

It is also, possible to envisage using a data aggregation module and/or a data consolidation module.

Reference should now be made to FIG. 6 to describe an example of a method for inputting accounts data. In this case, accounts data concerning-a local, firm (or branch) will be input using an input module 20.

This input method commences with a step 400 in which the user establishes a connection with supervision module 9, for example a private Intranet type network, by transmitting its identifier. Once the connection is established, the supervision module 9 engages in a user identification procedure, in a step 410. To this end, it compares the user's identifier with identifiers stored in memory 10. Then it determines the functions that the user is authorised to carry out.

In a step 420, the input masks are displayed on the user's screen. Preferably, all of the non-authorised functions and/or zones are masked or invalidated. In the example shown in FIG. 5, the authorised function is input followed by validation (or registration) of accounts data. The user then inputs.

In a step 430, the user selects either to validate the input data (complete data) or to create a temporary fuzzy file that must be stored outside the database with a view to supplementing it, for example. In the second hypothesis, the fuzzy file is created and stored in a step 435, then step 420 is revisited with a view to completing or modifying the data in the fuzzy file, while in the first hypothesis, we pass on to step 440.

In this step 440, we determine the chart of accounts and/or associated journals, local or group, which will allow conversion of the data either into the group format if they are input in a local format, or in, the local format if they are input, in the group format. Then conversion is carried out. If a problem arises, an error messages is generated in a step 445 which is addressed to the administrator with a view to correcting the correspondence tables in a step 450.

In contrast, if all goes well, the local or group currency is determined in a step 460, which allows the conversion of data either into the group format if they are input in a local format or in a local format if they are input in the group format. Then conversion is carried out. If a problem arises, an error message is generated in a step 465 which is addressed to the administrator with a view to correction of the correspondence tables in a step 450.

In contrast, if all goes well, step 470 generates a data flow history which is transmitted to the user and the input data is labelled. As indicated, above, this consists of adding an input identifier and the identifier of the user to the input data.

Finally, in a step 480, the data in the different zones 12, 14, 16 and 17 of database 4 are integrated.

In the methods described above, the access authorisations can be subdivided into two types. A first type concerns the administrator functions, while a second type concerns the user functions, whether of a local firm of a group.

The administrator's functions allow the creation and modification of parameters such as accounting years/periods, currencies, chart of accounts, the creation and modification of conversion filters adapted to each user, the creation and modification of entities (or local firms or branches), the creation and modification of account correspondence tables, the creation and modification of users and their authorisations for the different functions, the control of data flows at the inlet to and outlet from the database, management of the database (volume, purge, safety, and the like), file deposition, file export, data consultation, or the creation of spreadsheets, for example Excel.

Depending on the associated rights, the user functions primarily allow the deposit of files, export of files, consultation of the database, and the creation of spreadsheets.

By way of example, consultation of the data stored in the database provides access to the detailed records, to the totals for different accounts, whether in the local format or in the group format. Clearly, consultation can be on the basis of periods/accounting years and/or entities and/or journals and/or accounts.

The above description relates to a reserved type equipment in which the database is dedicated to a unique group of firms. Clearly, it is possible to envisage equipment being shared by a plurality of groups of firms. In this case, it is clear that the data can be stored in different group formats.

Further, the device can be used to define accounts from received and/or input accounting records. In this way, it is possible to calculate automatically and display online either intermediate balances, for example of the gross turnover, working capital or annual income type, net financial statements and the like, or accounts in a plurality of different accounting standards, for example French, American, (US GAAP), or an international standard (IASC). To this end, the user must first define a code, description and mathematical formula for calculating the account from the imported accounts, using conventional operators +, −, /, *, for an identical or different period, for example for automatic calculation of exchange rates. Then, the device carries out local and group synthesis and automatically generates the accounts.

Further, the logical connection between the entities (or local firms) combined with the generation of calculated accounts can allow consolidation logic to be generated that automatically produces consolidated accounts for the group or for its business units.

The device of the invention can also recognise different bank exchange formats.

By dint of the invention, each local firm (or branch or entity) of a group remains free to choose the software that is best suited to its size and to its local requirements. Further, all of the accounts data can move from upstream to downstream in the equipment and vice versa, regardless of whether it is from a local terminal to a server or from a local terminal to a group terminal, or again from a local terminal to another local terminal. Further, the invention ensures fluidity of information and data traceability.

Finally, the invention allows each group and any qualified accountants and other auditors to obtain complete information (detailed and aggregated) on all of their local firms. It is then possible to control, analyse and input data at group level, and to ensure centralised management at the group level for at least some of the local firms in that group.

This also allows delocalisation at group level or at one of the group's firms, of purchasing management, of various operations, of financial statements and the like.

The invention is not limited to the embodiments of the device, equipment and method described above solely by way of example, but encompasses all variations that may be envisaged by the skilled person within the scope of the following claims.

1. A device for processing accounts data, characterized in that it comprises:
a supervision module (9) provided with a memory (10) in which identification data for local terminals (1-i) are stored, each terminal being provided with local accounting software module (6-i) which can deliver data representing detailed accounts in a local format and accompanied by identification data, with a view to their transmission over a telecommunications network, and arranged to receive said detailed local accounts data and said identification data transmitted over a telecommunications network by said local terminals (1-i), and to communicate the detailed local accounts data which are accompanied by identification data stored in said memory (10); and
an interface module (11) arranged to convert detailed local accounts data communicated by said supervision module (9) into detailed local accounts data in the format of a database (4) with a view to memorising them in a selected first local zone (12) of said database (4).

2. A device according to claim 1, characterized in that said local format far the detailed local accounts data transmitted by a local terminal (1-i) relates to a local chart of accounts and/or a local currency and/or local journals.

3. A device according to claim 1, characterized in that said interface module (11) comprises a memory (25) in which correspondence tables between the local formats of the local terminals and the format of the database (4) are stored, so that said conversion can be carried out.

4. A device according to claim 1, characterized in that it comprises a local summation module (13) arranged to extract at least some of the detailed local accounts data stored in the format of the base and associated with one and the same local terminal (1-i) from said first local zone (12), then generating from said extracted data local aggregated accounts data associated with said local terminal (1-i) and in the format of the database, and finally storing said aggregated local data in a second local zone (14) of said database (4).

5. A device according to claim 1, characterized in that it comprises a filter module (15) arranged to extract detailed local accounts data stored in the format of the database and associated with each local terminal (1-i) from said first local zone (12), then converting the extracted data into detailed accounts data in a global format, and finally storing said detailed global data in a first global zone (16) of said database (4).

6. A device according to claim 5, characterized in that it comprises a global summation module (13) arranged to extract at least some of the detailed global accounts data associated with one and the same local terminal (l-i) from the first global zone (16), then generating from said extracted data, global aggregated accounts data associated with said local terminal (1-i) and in the global format, and finally storing said local aggregated data in a second global zone (17) of said database (4).

7. A device according to claim 5, characterized in that said global format for the detailed and/or aggregated accounts data stored in the database relates to a global chart of accounts and/or a global currency and/or global journals.

8. A device according to claim 5, characterized in that certain local charts of accounts comprise accounts data for distribution into at least two global charts of accounts by said filter module (15).

9. A device according to claim 4, characterized in that it comprises an export module (18) arranged, on receipt of a request emitted by a global terminal (2) identifiable by identification data, to extract at least some of the detailed global data stored in the first global zone (16) and/or at least some of the global aggregated data stored in said second global zone (17), to transmit them to said requesting global terminal (2).

10. A device according to claim 9, in which said global terminal comprises global accounting software (7), characterized in that said export module (18) is arranged to supply said group terminal (2) with data on request, and in that said supervision module (9) is arranged to receive detailed accounts data in the global format associated with a local terminal (1-i) and accompanied by identification data for said global terminal (2) from the global terminal (2), via a telecommunications network.

11. A device according to claim 10, characterized in that the memory (10) of the supervision module (9) stores identification data for the global terminals (2) and in that said supervision module (9) is arranged, on reception of detailed accounts data in global format moving in said network, to transmit to said interface module (11) detailed accounts data in the global format which are accompanied by identification data stored in said memory (10), so that they are stored in the database (4).

12. A device according to claim 5, characterized in that said filter module (15) is arranged to extract from said first global zone (16) detailed accounts data in the global format associated with one said local terminal (1-i), then to convert said extracted data into detailed local accounts data in the format of the database, and finally to store said detailed local data in the first local zone (12) of said database (4).

13. A device according to claim 1, characterized in that it comprises a plurality of connection modules (21-i, 22, 23) that can be installed in the different local terminals (1-i) and global terminals (2), with a view to being supplied with accounts data, and comprising a memory (24) storing, the address of the supervision module (9), and arranged to transmit said data to the supervision module (9) via said telecommunications network.

14. A device according to claim 13, characterized in that said connection module (21-i) of a local terminal (1-i) is arranged to place said detailed local accounts data in data fields that are separated from each other by field indicators, then to constitute a file comprising said data and said indicators, and finally to transmit said file to said supervision module (9), and in that said interface module (11) is arranged to detect said field indicators to carry out said conversion of said detailed local accounts data into detailed local accounts data in the format of the database prior to their being memorised.

15. A device according to claim 13, characterized in that, in the event of modification of the local chart of accounts and/or local journals, said connection module (21-i) is arranged to send the supervision module (9) a message indicating said modification.

16. A device according to claim 15, characterized in that, in the event of receipt of a message for modification of a local chart of accounts and/or local journals by said supervision module (9), said interface module (11) is arranged to modify said database format when said modification to the chart of accounts and/or journals is applied.

17. A device according to claim 16, characterized in that said interface module (11) is arranged, in the event of a need for a modification to the database format, to order the supervision module(9) to transmit a message requesting confirmation of the modification to the local terminal that emitted the message for modifying the local chart of accounts and/or local journals, with a view to carrying out a definitive modification of said database format.

18. A device, according to claim 1, characterized in that said interface module (11) is arranged to convert, on request, detailed local accounts data in the format of the database stored in the first local zone (12) associated with a local terminal (1-i), into detailed local accounts data, with a view to their transmission to said local terminal via said supervision module (9) and said network.

19. A device according to claim 1, characterized in that it comprises an input module (20) arranged, as a function of the authorisations delivered by an administrator, to firstly input events that are subsequently transformable into accounts by an authorised user, and secondly, to input directly into the database any data modifying or completing the data received from the local firms, inputting possibly being carried out in a local format or in a group format.

20. A device according to claim 1, characterized in that said interface module (11), supervision module (9), summation module (13), export module (18), filter module (15) and input module (20) are installed in a server (3) connected to a telecommunications network.

21. Equipment for processing accounts data, characterized in that it comprises:
a database (4) arranged to store accounts data in a selected database format;
at least two local terminals (1-i) each comprising local accounting software (6-i) for supplying data representing detailed accounts in a local format, each arranged so that the accounts data is accompanied by identification data, and each connected to at least one telecommunications network; a
at least one global terminal (2) connected to a telecommunications network; and
a data processing device (8) according to any one of the preceding claims, connected to said network and to said database (4).

22. An equipment according to claim 21, characterized in that said global terminal, (2) comprises global accounting software module (7) that can transmit to the supervision module (9) of said device (8), via a telecommunications network, detailed accounts data in a global format associated with a local terminal and accompanied by identification data for said global terminal (2).

23. A method for processing accounts data, characterized in that it comprises at least the following steps:
a) providing a data processing device (8) connected to a telecommunications network and to an accounts database (4) that can store accounts data in a selected base format, and at least two local terminals (1-i) connected to the network and each comprising local accounting software (6-i) which delivers data representing detailed accounts in a local format;
b) storing identification data for said local terminals (1-i) in a memory (10) of the device (8);
c) establishing a connection, via said network, between a local terminal (1-i) and said device (8), to transmit to said device detailed local accounts data accompanied by identification data;
d) converting the detailed local accounts data, which are accompanied by identification data stored in the memory (10), into detailed local accounts data in the format of said database, then memorising said data in a selected first local zone (12) of said database (4).

24. A method according to claim 23, characterized in that said local format for detailed local accounts data transmitted by a local terminal is related to a local chart of accounts and/or a local currency and/or local journals.

25. A method according to claim 23, characterized in that in step b), correspondence tables between the local formats for the local terminals and the format of the database (4) are stored so as to carry out said conversion of step d).

26. A method according to claim 23, characterized in that it comprises a step e) in which at least some of the detailed local accounts data associated with a unique local terminal (1-i) are extracted from said first local zone (12) in the database format, then the extracted data is used to generate local aggregated accounts data associated with said local terminal and in the database format, and finally said aggregated local data is stored in a second local database zone (14) of said database (4).

27. A method according to claim 23, characterized in that it comprises a step f) in which detailed local accounts data associated with one local terminal (1-i) are extracted from said first local zone (12) in the database format, then said extracted data is converted into detailed accounts data in a global format, and finally said global detailed data is stored in a first global zone (16) of said database (4).

28. A method according to claim 27, characterized in that it comprises a step g) in which at least some of the detailed global accounts data associated with one and the same local terminal (1-i) are extracted from said first global zone (16), then the extracted data is used to generate aggregated global accounts data associated with said local terminal and in the global format, and finally said local aggregated data is stored in a second global zone (17) of said database (4).

29. A method according to claim 27, characterized in that said global format for the detailed and/or aggregated global accounts data stored in the database is related to a global chart of accounts and/or a global currency and/or global journals.

30. A method according to claim 27, characterized in that in step f), certain accounts data belonging to certain local charts of accounts are distributed into at least two global charts of accounts.

31. A method according to claim 26, characterized in that it comprises a step i) in which, on request from a global, terminal (2) identifiable by identification data, at least, some of the detailed global data stored in the first global zone (16) and/or at least some of the global aggregated data stored in said second global zone(17) are extracted, then said extracted data are transmitted to said requesting global terminal (2).

32. A method according to claim 31, in which a global terminal (2) provided with global accounting software (7) is provided, characterized in that it comprises a step j) in which the global terminal (2) transmits detailed global accounts data in the global format associated with a local terminal and accompanied by identification data, to the device (8) via a telecommunications network.

33. A method according to claim 32, characterized in that in step b), identification data for the global terminals (2) are stored in said memory (10) and in that it comprises at the outlet from step j) a step k) in which the accounts data received in said first global zone (12) of the database (4) are stored.

34. A method according to claim 27, characterized in that it comprises a step 1) in which detailed accounts data in the global format associated with one of the local terminals (1-i) are extracted from said first global zone (16), then said extracted data is converted into detailed local accounts data in the database format, and finally said local detailed data is stored in said first local zone (12) of said database (4).

35. A method according to claim 23, characterized in that in step c), the detailed local accounts data is placed in data fields separated from each other by field indicators, then a file comprising said data and indicators is constituted, then the file is transmitted to said device (8), and in that in step d), conversion is carried out after detecting the field indicators.

36. A method according to claim 23, characterized in that, it comprises a-step m) in which a message indicating each modification in the local chart of accounts and/or a local journal is addressed to said device (8).

37. A method according to claim 36, characterized in that it comprises, at the outlet from step m), a step n) in which said database format is modified when the chart of accounts and/or journal are modified.

38. A method according to claim 37, characterized in that in step n), the local terminal (1-i) emitting a modification message is required to confirm modification before proceeding to, definitive modification of the database format.

39. A method according to claim 23, characterized in that it comprises a step o) in which, on request, detailed local accounting data in the database format associated with a local terminal (1-i) stored in the first local zone (12) are converted into detailed local accounts data, then said converted data are transmitted to a local terminal (1-i) designated in said request.

40. Use of a device, equipment and method according to any one of the preceding claims in the field of telecommunications networks selected from a group comprising public and private networks.
